(19) United States
(12) Patent Application Publication
(10) Pub. No.: US 2008/0302823 A1
(43) Pub. Date: Dec. 11, 2008

(54) COUPLING DEVICE AND KIT FOR A CLEANING FLUID DISPENSER

(76) Inventor: Barbara Young, Raleigh, NC (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/760,439

(22) Filed: Jun. 8, 2007

(51) Int. Cl. B67D 1/08

(52) U.S. Cl. 222/148

(57) ABSTRACT

Disclosed herein is a coupling device for coupling a counter mounted fluid dispenser to a cleaning fluid reservoir. The coupling device includes a conduit configured to couple to a portion of the cleaning fluid dispenser. The coupling device also includes a cleaning-fluid reservoir coupler. The cleaning fluid reservoir coupler is configured to couple to an opening of a cleaning fluid reservoir. The conduit extends through at least a portion of the cleaning fluid reservoir coupler. In use, the conduit is movably positionable through the reservoir coupler such that a second end of the conduit is positioned with the cleaning fluid disposed in the cleaning fluid reservoir.

### BACKGROUND OF THE INVENTION

1. Field of the Invention

The invention generally relates to a coupling device for coupling a cleaning fluid dispenser to a cleaning fluid reservoir. The invention also generally relates to kits that include components that allow coupling of a cleaning fluid dispenser to a cleaning fluid reservoir.

2. Description of the Relevant Art

With the advent of liquid or gel cleaning fluids (e.g., hand soap and dish soap), many types of dispensers have been developed that may be positioned near a water dispensing area. For example, bathrooms and kitchens will usually have at least one sink that includes one or more faucets. To facilitate and encourage the use of a cleaning fluid by users, a cleaning fluid dispenser may be positioned near the faucets. For example, in the kitchen, a cleaning fluid dispenser may be installed proximate to the kitchen sink to allow a user to quickly access cleaning fluid while washing dishes or to wash their hands. Similarly, in bathrooms, a cleaning fluid dispenser is usually positioned or mounted in the bathroom to allow a user of the bathroom ready access to cleaning fluid for washing their hands.

A typical cleaning fluid dispenser is depicted in FIG. 1. The cleaning fluid dispenser includes a pump 102 and a reservoir 112 that maintains a supply of cleaning fluid. Pump 102 draws cleaning fluid from the reservoir and dispenses the cleaning fluid through outlet 104 to a user. The pump is typically a hand operated pump, although the pump can be electric or pneumatically operated. The cleaning fluid dispenser may be mounted to a countertop near a faucet or other type of water outlet. Typically a compression fitting is used to secure the cleaning fluid dispenser to the countertop. For example, a conduit 108 may extend from the pump and through the counter top. A fastener 110 may be secured to the conduit 108 to secure the cleaning fluid dispenser to the countertop. Typically conduit 108 is a threaded conduit that can receive a complementary threaded fastener 110.

As shown in FIG. 1, a cleaning fluid dispenser mounted in this manner is positioned such that the pump portion 102 and outlet 104 of the soap dispenser are visible, while the reservoir is typically hidden under the countertop. While such a design helps create a more aesthetically pleasing appearance, the positioning of the reservoir “out-of-sight” of the user can make it difficult to replenish the cleaning fluid supply when the reservoir runs out of soap. Typically, a user must remove the visible portion (e.g., a portion 102) from the reservoir and refill the reservoir by pouring additional soap into the reservoir. This method may be inconvenient due to the necessity of disassembly of the soap dispenser, which typically leads to cleaning fluid being spilled onto the countertop. Additionally, since the reservoir is typically hidden from view, it is difficult to know when the reservoir is nearly full, and thus overfilling of the reservoir can be a problem. Finally, even if the reservoir is not overflowing, when the user has finished adding cleaning fluid to the reservoir, leakage of cleaning fluid onto the counter will typically occur due to displacement of the cleaning fluid when pump portion 102 is placed back into position. Due to space and weight constraints, many counter mounted cleaning fluid dispensers include a low volume cleaning fluid reservoir. Such reservoirs typically hold less then about 1 L of liquid. This leads to the need to add cleaning fluid back to the reservoir on a frequent basis, especially for high use areas such as the kitchen and bathrooms.

These problems, while mainly inconveniences for users, often act a significant deterrent to refilling the dispenser. Thus, many homes that have such counter mounted cleaning fluid dispensers installed will stop using the dispensers because they have become empty. It is therefore desirable to have a more convenient and efficient system and method of allowing a supply of cleaning fluid to be replaced to a mounted soap dispenser.

### SUMMARY OF THE INVENTION

Disclosed herein is a coupling device for coupling a counter mounted fluid dispenser to a cleaning fluid reservoir. The coupling device includes a conduit configured to couple to a portion of the cleaning fluid dispenser. The coupling device also includes a cleaning-fluid reservoir connector. The cleaning fluid reservoir connector is configured to couple to an opening of a cleaning fluid reservoir. The conduit extends through at least a portion of the cleaning fluid reservoir coupler. In use, the conduit is movably positionable through the reservoir coupler such that a second end of the conduit is positioned with the cleaning fluid disposed in the cleaning fluid reservoir. In some embodiments, the conduit is a substantially flexible conduit.

In some embodiments, the cleaning fluid dispenser is a hand-pump type dispenser. Alternatively, the cleaning fluid dispenser may include an electric pump for automatic or semi-automatic operation. A dispenser may include a pump, the pump having a body and a recess formed in the body. The first end of the conduit may be positioned within at least a portion of the recess. Alternatively, the pump may further include a second conduit, coupled to the recess of the body. The first conduit may be coupled to the second conduit, such that the cleaning fluid passes from the cleaning fluid reservoir, through the first conduit to the second conduit, and through the second conduit to the pump.

A variety of different cleaning fluid reservoir couplers may be used. Examples of cleaning fluid couplers include a stopper-type coupler, a screw cap type coupler, an elastic coupler, or a quick-disconnect type coupler. In some embodiments, a plurality of cleaning fluid reservoir couplers may be bundled with the conduit in a kit. Each of the plurality of cleaning fluid reservoir couplers may be configured to couple with commercially available cleaning fluid containers.

A coupling device may be coupled to an existing counter mounted fluid dispenser. A first end of the conduit may be coupled to the counter mounted fluid dispenser. The conduit may be passed though a cleaning fluid reservoir coupler. The cleaning fluid reservoir coupler may be coupled to a cleaning fluid reservoir. The position of the conduit with respect to the cleaning fluid reservoir coupler may then be adjusted such that the second end of the conduit extends into the cleaning fluid disposed in the reservoir. In some embodiment, a cleaning fluid reservoir coupler may be preselected from a plurality of couplers included with a kit that also includes the conduit.

### BRIEF DESCRIPTION OF THE DRAWINGS

Other objects, features and advantages of the invention will appear on reading the following description, given as a non-limiting example, and made with reference to the appended drawings in which:

FIG. 1 depicts a prior art cleaning fluid dispenser;

FIG. 2 depicts a perspective view of a typical cleaning fluid dispenser pump;

FIG. 3 depicts a schematic view of a coupling device coupling a cleaning fluid dispenser coupled to a cleaning fluid reservoir; and

FIG. 4 depicts a schematic view of an alternate embodiment of a coupling device that couples a cleaning fluid dispenser to a cleaning fluid reservoir.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

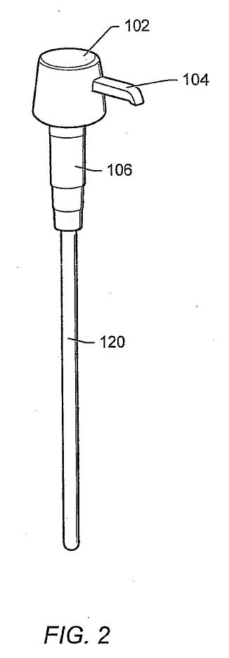

Depicted in FIG. 2, is a perspective view of a typical cleaning fluid dispenser. The fluid dispenser includes a pump 102. Pump 102 includes a body 106 that contains a pump mechanism (not shown). An outlet 104 extends from body 106 and provides a passage for cleaning fluid to flow out of pump 102. It should be appreciated that any type of pump mechanism capable of drawing a may be contained within pump 102, including, but not limited to mechanical (e.g., hand operated) and electrical pumping mechanisms. A conduit 120 is coupled to the pump mechanism and extends out of body 102. During use, conduit 120 is positioned in a cleaning fluid reservoir (not shown) and provides a passage for cleaning fluid to flow from the cleaning fluid reservoir, through conduit 120, and into the pump mechanism. The pump mechanism provides the necessary forces to pull cleaning fluid from the cleaning fluid reservoir and expel the collected cleaning fluid through outlet 104 to the user.

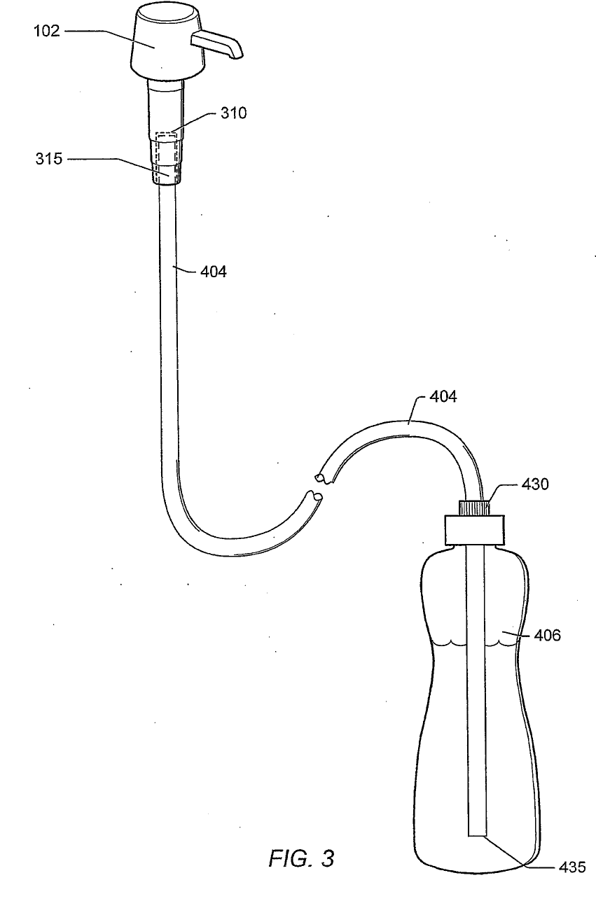

As previously noted, a cleaning fluid reservoir is typically connected to the bottom portion of a pump and the conduit, extending from the bottom of the pump, is positioned in the cleaning fluid contained in the cleaning fluid reservoir. Such systems, however, may suffer from the drawbacks previously discussed. An improved system includes a cleaning fluid dispenser that is coupled to a remote cleaning fluid reservoir, e.g., a reservoir that is not connected to the pump, using a coupling device. One embodiment of such a system is depicted in FIG. 3. As shown, the conduit and connected reservoir that normally extend from the pump may be removed and replaced with extended conduit 404. In some embodiments, conduit 404 is a substantially flexible conduit. For example, conduit 404 may be formed from a plastic or rubber material. Any of a variety of material may be used to form the conduit 404. Examples include, but are not limited to metal tubing (e.g., stainless steel and copper), plastic tubing (PVC, polyethylene, etc.), rubber tubing, or braided tubing (e.g., tubing that is a combination of metal and plastic).

In an embodiment, a cleaning fluid dispenser may include a pump 102 that includes a recess 310 into which a conduit 404 may be positioned. A first end 315 of conduit 404 may be positioned inside of recess 310. A variety of couplings may be used to secure conduit 404 within recess 310. In one embodiment, first end 315 of conduit 404 may have an outer diameter that is substantially equal to the inner diameter of recess 310. The conduit may therefore be secured by a “frictional fit” in which the contact between the inner surface of the recess and the conduit inhibits the conduit from coming out of the recess. It should be understood that any of numerous devices and configurations that can be used to couple a conduit to a pump may be used in any of the described embodiments. In some embodiment, it may be necessary to remove an existing reservoir connected to the counter in order to access the pump. The connected reservoir may be discarded after removal, since the remote reservoir will effectively take the place of the connected reservoir.

The other end of conduit 404 may be coupled to a cleaning fluid reservoir 406. Conduit 404 may be coupled to cleaning fluids reservoir by cleaning fluid reservoir coupler 430. Conduit 404 extends through cleaning fluid reservoir coupler 430 and into cleaning fluid reservoir 406. The second end 435 of conduit 404 is positioned under the upper surface of the cleaning fluid disposed in cleaning fluid reservoir 406. The position of the end of conduit 404 with respect to the cleaning fluid and the top of cleaning fluid reservoir is adjustable by sliding the conduit through cleaning fluid reservoir coupler 430. With the first end of conduit 404 coupled to pump 102 of the cleaning fluid dispenser and the second end 435 of conduit 404 coupled to cleaning fluid reservoir 406, cleaning fluid may be transferred from the reservoir to the pump. The remote location of the cleaning fluid reservoir with respect to the pump allows for easier replenishing of the cleaning fluid. When the cleaning fluid reservoir is empty, or nearly empty, the cleaning fluid reservoir coupler 430 and conduit 404 are removed from the cleaning fluid reservoir. After the conduit is removed from the cleaning fluid reservoir, additional cleaning fluid may be added back to the reservoir and the system may be reassembled. Alternatively, a filled cleaning fluid reservoir may be used to replace the depleted cleaning fluid reservoir by simply transferring the conduit from the empty, or nearly empty, cleaning fluid reservoir to the new cleaning fluid reservoir.

The cleaning fluid reservoir may be placed in an easily accessible remote location. For example, if the cleaning fluid dispenser is installed next to a kitchen sink, the cleaning fluid reservoir may be placed on a floor of the cabinet underneath the sink. This placement may allow easy access to the cleaning fluid reservoir by a user, as opposed to reservoirs that are connected to the pump at the interface of the countertop. The use of a coupling device to remotely couple a cleaning fluid reservoir to a cleaning fluid dispenser allows the cleaning fluid supply to be replaced in an efficient manner that does not suffer from the inconveniences described above for the typical cleaning fluid dispenser system.

The cleaning fluid reservoir may be any container capable of holding a cleaning fluid. As used herein the term “cleaning fluid” encompasses hand soaps, bath soaps, dishwashing soaps, disinfectants (e.g., for hospital use), household cleaning products, polishes, waxes, etc. Many different commercially available cleaning fluids are can be used and are typically provided in a container. In an embodiment, cleaning fluid reservoir coupler 430 is capable of coupling with the outlet of one or more commercially available cleaning fluid containers.

Since different commercially available cleaning fluid containers will come with different types of outlets, different types of cleaning fluid reservoir coupler may be used. For example, the cleaning fluid reservoir coupler may be a stopper-type coupler. A stopper type coupler may include a stopper with at least one opening in the stopper that will allow the conduit to pass through the stopper. The stopper may be tapered or untapered and have an outer diameter that is substantially equal to an inner diameter of an outlet to the fluid reservoir. In use, the stopper-type coupler may be inserted into the opening to allow the conduit to be positioned within the cleaning fluid contained in the cleaning fluid reservoir.

In another embodiment, the coupler may be a screw-cap type connector. A screw-cap type connector may include a threaded connector that has threading complementary to the threading of commercially available cleaning fluid containers. A variety of screw-cap connectors may be packaged together with the conduit to allow the conduit to be coupled to a variety of commercially available cleaning fluid reservoirs. In use, the screw-cap type coupler may replace the screw cap of a cleaning fluid container and the conduit may be inserted thorough the screw-cap connector into the fluid reservoir.

In another embodiment, the cleaning fluid reservoir coupler may be an elastic coupler. An elastic coupler may be formed from an elastic material that may be stretched to fit over an opening of the fluid reservoir. For example, many cleaning fluid containers may include a screw-cap fitting. In an embodiment, the screw cap may be removed and the elastic coupling may be stretched over the screw cap fitting. A variety of elastic couplers may be packaged together with the conduit to allow the conduit to be coupled to a variety of commercially available cleaning fluid reservoirs. In use, the conduit may be inserted thorough an opening in the elastic coupling and into the fluid reservoir.

Regardless of the type of coupler used, in some embodiments, one or more vent holes may be formed in the coupler to allow the passage of air into the container as the fluid is drawn out through the conduit by the action of the pump. The passage of air into the container will help equalize the pressure in the container due to the partial vacuum that is created as the cleaning fluid is removed form the container.

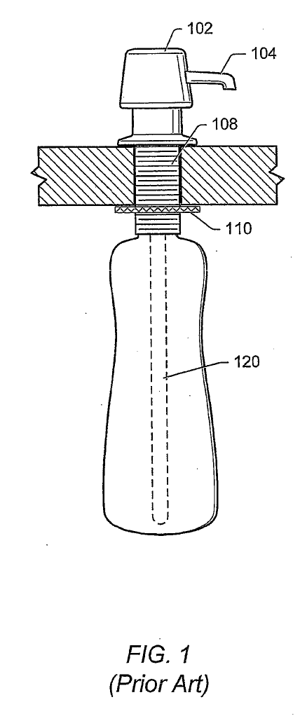

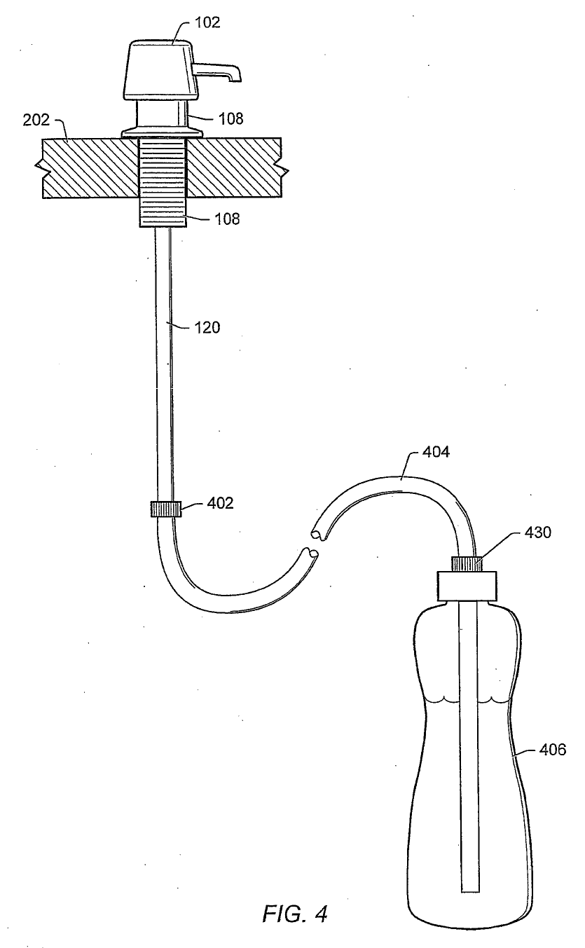

In another embodiment, a coupling device may include a first coupler 430, a second coupler 440, and conduit 404 as depicted in FIG. 4. The first coupler 430 may be used to couple conduit 404 to cleaning fluid reservoir 406. The second coupler may be used to couple conduit 404 to a pump conduit 120 that is part of a cleaning fluid dispenser. For example, referring to FIG. 1, a typically fluid dispenser includes a pump 102 that has a pump conduit 120 extending from the pump into reservoir 112. Removal of reservoir 112 will allow pump conduit 120, extending from the pump to be accessible. A coupler 440 may be used to couple the conduit 404 to pump conduit 120. In an alternate embodiment, a coupler may not be needed and conduit 404 is simply fitted over pump conduit 120 or inserted into the pump conduit. Such embodiments that use an existing pump conduit may have an advantage of not requiring any substantial changes to the pump and may be implemented by simply removing the existing fluid reservoir and coupling the conduit onto the pump conduit.

In an embodiment, the conduit and a series of adapters and couplers may be packaged together and sold as a kit. The kit may include a plurality of couplers and at least one conduit. The couplers may include a variety of sizes of a variety of different types of couplers (e.g., stopper type couplers, screw-cap couplers, elastic couplers, etc.). Ideally the couplers are designed to fit most of the known commercially available cleaning fluid containers. Additionally, one or more adapters may be included to allow the conduit to be fitted to a variety of pumps. Such a kit may be useful for allowing a person to customize the coupling device to match their equipment by providing all of the components that would be required to create the new coupling under most circumstances.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. A coupling device that couples a counter mounted cleaning fluid dispenser to a cleaning fluid reservoir, comprising:
a conduit, wherein a first end portion of the conduit is configured to couple to the dispenser; and
a cleaning-fluid reservoir coupler, wherein the reservoir coupler is configured to couple with an opening in the cleaning fluid reservoir;
wherein the conduit extends through at least a portion of the reservoir coupler and the conduit is movably positionable through the reservoir coupler such that a second end of the conduit is positioned in cleaning fluid in the cleaning fluid reservoir.

2. The coupling device of claim 1, wherein conduit is a substantially flexible conduit.

3. The coupling device of claim 1, wherein the dispenser is a hand-pump type dispenser.

4. The coupling device of claim 1, wherein the dispenser comprises a pump, wherein pump comprises a body and a recess formed in the body, and the first end of the conduit is positioned inside at least a portion of the recess when the conduit is coupled to the dispenser.

5. The coupling device of claim 1, wherein the dispenser comprises a pump and a pump conduit configured to convey cleaning fluid to the pump, and wherein the first end of the conduit has an inner diameter that is substantially equal to an outer diameter of the pump conduit, and wherein the first end of the conduit is positioned over at least a portion of the pump conduit when the conduit is coupled to the dispenser.

6. The coupling device of claim 5, further comprising a dispenser coupler connected to the pump conduit, wherein the dispenser coupler is configured to receive the first end of the conduit and couple the conduit to the pump dispenser.

7. The coupling device of claim 1, wherein the reservoir coupler is a stopper-type coupler.

8. The coupling device of claim 1, wherein the reservoir coupler is a screw cap type coupler.

9. The coupling device of claim 1, wherein the reservoir coupler is an elastic coupler.

10. The coupling device of claim 11, wherein the reservoir coupler comprises one or more holes to allow air to enter the cleaning fluid reservoir through the holes in the reservoir coupler.

11. A kit for coupling a counter mounted cleaning fluid dispenser to a cleaning fluid reservoir, comprising:
a conduit, wherein a first end portion of the conduit is configured to couple to the dispenser; and
a plurality of cleaning-fluid reservoir couplers, wherein each of the reservoir couplers are configured to couple with openings of different cleaning fluid reservoirs;
wherein the conduit extends through at least a portion of any of the reservoir couplers and the conduit is movably positionable through any of the reservoir couplers such that a second end of the conduit is positioned in cleaning fluid in the cleaning fluid reservoirs.

12-21. (canceled)

22. A method of coupling a counter mounted cleaning fluid dispenser to a cleaning fluid reservoir, comprising:
coupling a first end portion of a conduit to the dispenser;
passing the conduit through a portion of a cleaning fluid reservoir coupler;
attaching the reservoir coupler to a cleaning fluid reservoir; and
moving the conduit through the reservoir coupler such that a second end of the conduit is positioned in cleaning fluid in the cleaning fluid reservoir.

23. The method of claim 22, wherein conduit is a substantially flexible conduit.

24. The method of claim 22, wherein the dispenser is a hand-pump type dispenser.

25. The method of claim 24, wherein the dispenser comprises a pump and a recess, and wherein the first end of the conduit has an outer diameter that is substantially equal to a diameter of the recess, wherein coupling a first end portion of a conduit to the dispenser comprises positioning the first end of the conduit inside at least a portion of the recess.

26. The method of claim 24, wherein the dispenser comprises a pump and a pump conduit configured to convey cleaning fluid to the pump, and wherein the first end of the conduit has an inner diameter that is substantially equal to an outer diameter of the pump conduit, coupling a first end portion of a conduit to the dispenser comprises positioning the first end of the conduit over at least a portion of the pump conduit.

27. The method of claim 26, further comprising a dispenser coupler connected to the pump conduit, and wherein coupling a first end portion of a conduit to the dispenser comprises coupling the dispenser coupler to the pump conduit and coupling the dispenser coupler to the first end of the conduit.

28. The method of claim 27, wherein the dispenser coupler is a quick-disconnect type coupler.

29. The method of claim 22, wherein the reservoir coupler is a stopper-type coupler.

30. The method of claim 22, wherein the reservoir coupler is a screw cap type coupler.

31. The method of claim 22, wherein the reservoir coupler is an elastic coupler.

32. The method of claim 22, wherein the reservoir coupler comprises one or more holes to allow air to enter the cleaning fluid reservoir through the holes in the reservoir coupler.

33. The method of claim 22, wherein the counter mounted cleaning fluid dispenser comprises a counter reservoir connected to the dispenser, and wherein the method further comprises removing the counter reservoir from the dispenser prior coupling a first end portion of a conduit to the dispenser.
